(19) United States
(12) Patent Application Publication
(10) Pub. No.: US 2014/0176017 A1
(43) Pub. Date: Jun. 26, 2014

(54) POWER SUPPLY SYSTEM, RIPPLE SUPPRESSION CIRCUIT AND ASSOCIATED METHOD

(71) Applicant: Chengdu Monolithic Power Systems Co. Ltd., Chengdu (CN)

(72) Inventors: Naixing Kuang, Hangzhou (CN); Hongxia Yu, Hangzhou (CN); Zhijun Ye, Hangzhou (CN)

(73) Assignee: Chengdu Monolithic Power Systems Co. Ltd., Chengdu (CN)

(21) Appl. No.: 14/140,344

(22) Filed: Dec. 24, 2013

(30) Foreign Application Priority Data
Dec. 24, 2012 (CN) 201210566389.7

(51) Int. Cl. G05F 5/00; H05B 33/08

(52) U.S. Cl. CPC G05F 5/00; H05B 33/0815
USPC 315/307; 323/312

(57) ABSTRACT

A power supply system having a voltage source; a load; a filter circuit to filter the voltage provided by the voltage source and to output a filtered voltage; and a follower circuit configured to generate an output signal at an output of the follower circuit based on the filtered voltage, and further wherein the output of the follower circuit is coupled to the load.

### CROSS-REFERENCE TO RELATED APPLICATION(S)

This application claims the benefit of CN application No. 201210566389.7, filed on Dec. 24, 2012, and incorporated herein by reference.

### TECHNICAL FIELD

The present invention refers to electrical circuit, to be more specific but not exclusively refers to power supply system, associated ripple suppression circuit and suppressing method in light emitting diode (LED) power supply system.

### BACKGROUND

Light Emitting Diode (LED) is widely used as a light source for advantages of low power dissipation and high light efficiency. A prior art LED power supply system adopts a single stage Power Factor Correction (PFC) voltage converter to drive LED. However, a single stage PFC voltage converter usually contains high output ripple. In order to decrease the ripple, a prior art solution adopts a large capacitor with high capacitance at the output of the voltage converter. However, this solution requires a large electrolyte capacitor which consumes large space and has short lifetime, and shortens the lifetime of the LED power supply system dramatically.

Accordingly, a ripple suppression circuit with small output capacitor is desired.

### SUMMARY

To at least overcome part of the above mentioned deficiencies, some embodiments of the present invention discloses a ripple suppression circuit, a power supply system and a method of suppressing ripple.

In one embodiment, a power supply system comprises: a voltage source configured to provide a voltage; a load; a filter circuit having an input and an output, wherein the input of the filter circuit is coupled to the voltage source, the filter circuit is configured to filter the voltage provided by the voltage source and provide a filtered voltage at the output of the filter circuit; and a follower circuit having a first input, a second input and an output, wherein the first input of the follower circuit is coupled to the voltage source, the second input of the follower circuit is coupled to the output of the filtered voltage, the follower circuit configured to generate an output signal at the output of the follower circuit based on the filtered voltage, and further wherein the output of the follower circuit is coupled to the load to supply the load.

In another embodiment, a ripple suppression circuit comprises: a filter circuit having an input and an output, wherein the input is coupled to a voltage source, the filter circuit is configured to filter a voltage provided by the voltage source and provide a filtered voltage at the output of the filter circuit; and a follower circuit having a first input, a second input and an output, wherein the first input of the follower circuit is coupled to the voltage source, the second input of the follower circuit is coupled to the output of the filter circuit, and the output of the follower circuit is configured to provide an output signal for supplying a load, wherein the output signal is generated based on the filtered voltage.

In yet another embodiment, a method of suppressing ripple in power supply system comprises: filtering a voltage provided by a voltage source and obtaining a filtered voltage; following the filtered voltage and generating an output signal based on the filtered voltage and the voltage provided by the voltage source; and supplying a load by the output signal.

### BRIEF DESCRIPTION OF THE DRAWINGS

Non-limiting and non-exhaustive embodiments are described with reference to the following drawings. The drawings are only for illustration purpose. Usually, the drawings only show part of the system or circuit of the embodiments.

FIG. 1 illustrates a block diagram of a power supply system according to an embodiment of the present invention.

FIG. 2 illustrates a ripple suppression circuit according to an embodiment of the present invention.

FIG. 3 illustrates a ripple suppression circuit according to an embodiment of the present invention.

FIG. 4 illustrates a ripple suppression circuit according to an embodiment of the present invention.

FIG. 5 illustrates a ripple suppression circuit according to an embodiment of the present invention.

FIG. 6 illustrates a detailed power supply system according to an embodiment of the present invention.

FIG. 7 illustrates a power supply system having a short protection circuit according to an embodiment of the present invention.

FIG. 8 illustrates a flowchart diagram of a ripple suppressing method, according to an embodiment of the present invention.

FIG. 9 illustrates a flowchart diagram of a method of suppressing ripple, according to an embodiment of the present invention.

FIG. 10 illustrates a method of suppressing ripple along with decreasing power dissipation, according to an embodiment of the present invention.

The use of the same reference label in different drawings indicates the same or like components.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

The phrase “couple” includes direct connection and indirect connection. Indirect connection includes connection through conductor such as metal wire, flip chip ball and lead frame which has resistance and/or parasitic parameters such as inductance and capacitance, connection through resistor or diode, and connection through the combination of the conductor(s), the resistor(s) and/or the diode(s), and so on.

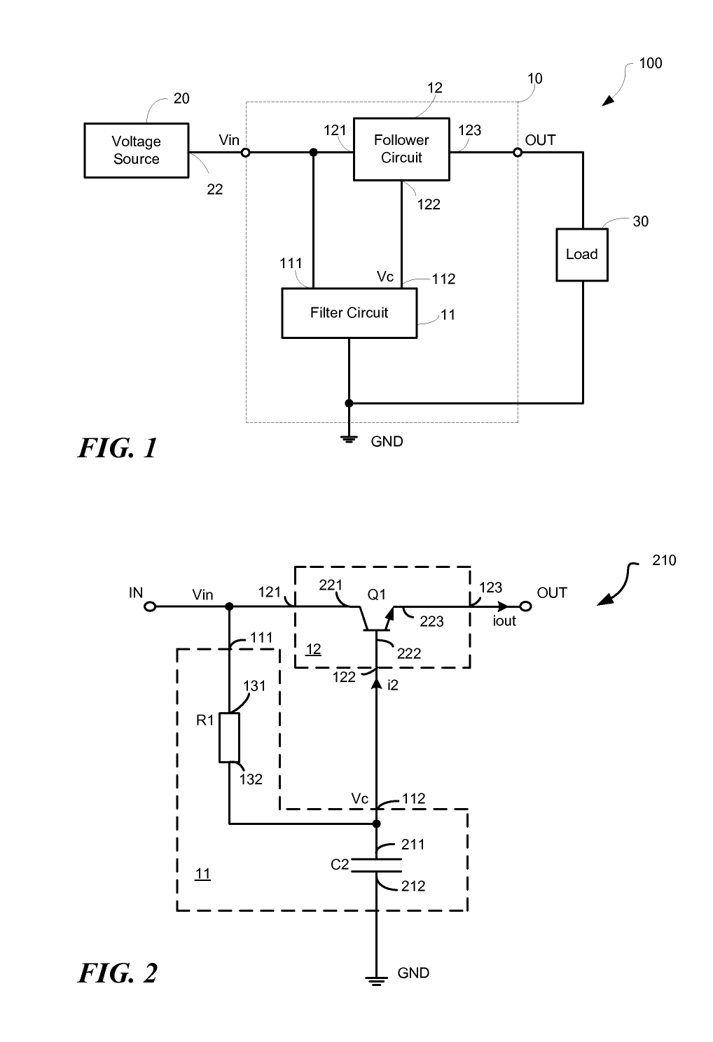

FIG. 1 illustrates a power supply system 100 according to an embodiment of the present invention. Power supply system 100 comprises a voltage source 20, a ripple suppression circuit 10 and a load 30.

Voltage source 20 has an output terminal 22 configured to provide a voltage Vin that contains ripple. Voltage source 20 can be any type or in any form, such as a voltage converter, an adapter, a chip, a circuit module, a wire or other type of conductor, which carries a voltage which contains ripple. The ripple can be in any form or level that makes the waveform of the voltage not an ideal straight line. In one embodiment, voltage source 20 comprises a voltage converter which converts an input voltage into a direct-current (DC) voltage Vin outputted at the output 22. In one embodiment, the voltage converter converts an alternating-current (AC) voltage into a DC voltage Vin. In another embodiment, the voltage converter converts a DC voltage into a DC voltage Vin. In one embodiment, voltage source 20 is regulated based on a feedback signal indicative the output voltage of voltage source 20. In another embodiment, voltage source 20 may be regulated based on a feedback signal indicative of the current flowing through a load, where the load is generally has a constant value during normal operation.

Ripple suppression circuit 10 is coupled between voltage source 20 and load 30. Ripple suppression circuit 10 generates an output signal OUT at the output to suppress the ripple in voltage Vin provided by voltage source 20, and supplies load 30 with the output signal OUT.

Ripple suppression circuit 10 comprises a filter circuit 11 and a follower circuit 12. Filter circuit 11 filters the voltage Vin provided by voltage source 20 and outputs a filtered voltage Vc at an output 112 of the filter circuit 11. Accordingly, voltage Vc has low ripple than voltage Vin. Filter circuit 11 has an input 111 and an output 112. Input 111 is coupled to voltage source 20, configured to receive voltage Vin which contains ripple. And output 112 is configured to provide the filtered voltage Vc of voltage Vin. The filtered voltage Vc reflects the average value of voltage Vin, but has a smoother waveform compared to voltage Vin, and the ripple is suppressed.

Follower circuit 12 makes the output signal OUT follow the filtered voltage Vc. Or in other words, the waveform or smoothness of output signal OUT follows the filtered voltage Vc. Follower circuit 12 has a first input 121, a second input 122 and an output 123. The first input 121 is coupled to voltage source 20 configured to receive voltage Vin, the second input 122 is coupled to the output 112 of filter circuit 11. The output 123 of follower circuit 12 is coupled to load 30, and provides output signal OUT for supplying load 30. Output signal OUT is generated based on the filtered voltage Vc and follows the filtered voltage Vc. Accordingly, the output signal OUT has smoother waveform shape compared to voltage Vin, and the ripple is suppressed. In one embodiment, output signal OUT is a voltage signal, and the voltage at the output 123 of follower circuit 12 is proportional to the filtered voltage Vc. In another embodiment, output signal OUT is a current signal, and the current at the output 123 of follower circuit 12 is proportional to the filtered voltage Vc.

In one embodiment, load 30 comprises a LED string having a plurality of LEDs coupled in series. In another embodiment, load 30 comprises a plurality of LED strings. In yet another embodiment, load 30 is a single LED. In some other embodiments, the load comprises a multiple LEDs other than the aforementioned configurations or comprises other types of load with any configuration.

FIG. 2 illustrates a ripple suppression circuit 210 according to an embodiment of the present invention. Ripple suppression circuit 210 comprises a filter circuit 11 and a follower circuit 12. Filter circuit 11 comprises a resistor R1 and a capacitor C2. Capacitor C2 has a first terminal 211 and a second terminal 212. The first terminal 211 is coupled to the output 112 of filter circuit 11 and to the second input 122 of follower circuit 12. The second terminal 212 of capacitor C2 is coupled to a reference ground GND. Resistor R1 has a first terminal 131 and a second terminal 132. The first terminal 131 of resistor R1 is coupled to the input 111 of filter circuit, and to the voltage source for receiving voltage Vin of a voltage source. The second terminal 132 of resistor R1 is coupled to the first terminal 211 of capacitor C2, and to the output 112 of filter circuit 11. Filter circuit 11 comprising resistor R1 and capacitor C2 generates a filtered voltage Vc at the output 112 of filter circuit 11. The filtered voltage Vc reflects the average level of voltage Vin but has a smoother waveform shape compared to voltage VIN, and the ripple is suppressed. In some other embodiments, the filter circuit has other configurations. In one embodiment, filter circuit 11 comprises a filtering network comprising a plurality of capacitors and a plurality of resistors. In one embodiment, the capacitance of capacitor C2 and the resistance of resistor R1 are adjustable.

The follower circuit 12 in the shown embodiment in FIG. 2 comprises a transistor Q1. Transistor Q1 has a first terminal 221, a second terminal 223 and a control terminal 222. The first terminal 221 of transistor Q1 is coupled to the first input 121 of follower circuit 12, and to the voltage source. The control terminal 222 of transistor Q1 is coupled to the second input 122 of follower circuit 12, and to the output 112 of filter circuit 11. In the shown embodiment, the control terminal 222 of transistor Q2 is coupled to the first terminal 211 of capacitor C2. The second terminal 223 of transistor Q1 is coupled to the output 123 of follower circuit 12. And the output 123 of follower circuit 12 is coupled to the load. The output signal OUT of the ripple suppression circuit 210 is the current signal iout flowing through the second terminal 223 of transistor Q1. Current signal iout is proportional to the current i2 at the control terminal 222 of transistor Q1, and iout=βi2, where β is the current amplification factor of transistor Q1. Current i2 follows the change of the filtered voltage Vc. Accordingly, the output signal iout also follows the waveform shape of the filtered voltage Vc. Thus the value of output current iout is smooth and ripple is suppressed. In the shown embodiment, follower circuit 12 comprises an N-type bipolar junction transistor (BJT) Q1, and the first terminal 221 of transistor Q1 is a collector, the second terminal 223 is an emitter and the control terminal 222 is a base, wherein the emitter current iout is proportional to the base current i2 of transistor Q1, and the emitter current iout is an amplified signal from current i2. In one embodiment, transistor Q1 comprises a P-type transistor. In another embodiment, follower circuit 12 comprises any type of current amplifying circuit or current amplifying apparatus, where the current flowing through the output 123 of follower circuit 12 is proportional to and higher than the current at the second input 122 of the follower circuit. In one embodiment, the second input 122 of follower circuit 12 comprises parasitic resistance.

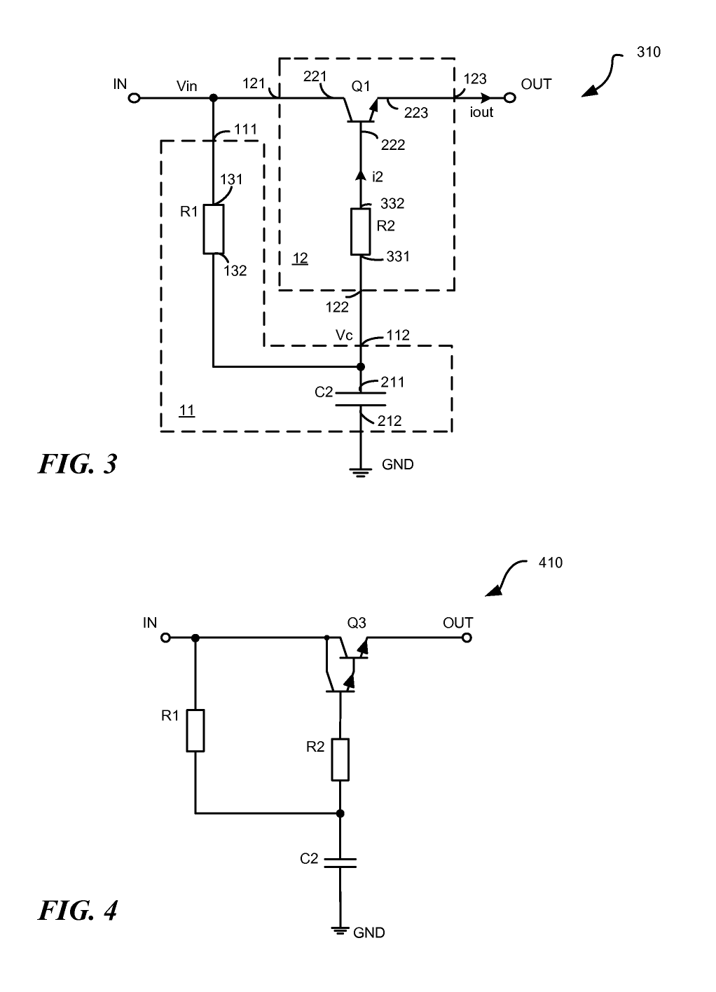

FIG. 3 illustrates a ripple suppression circuit 310 according to another embodiment of the present invention. Compared to ripple suppression circuit 210 shown in FIG. 2, ripple suppression circuit 310 further comprises a second resistor R2. The second resistor R2 comprises a first terminal 331 and a second terminal 332. The first terminal 331 of resistor R2 is coupled to the output 112 of filter circuit 11, and to the second input 122 of follower circuit 12. In the shown embodiment, the first terminal 331 of resistor R2 is coupled to the first terminal 211 of capacitor C2. The second terminal 332 of the second resistor R2 is coupled to the control terminal 222 of transistor Q1. In one embodiment, the second resistor R2 is used to decrease the current flowing at the control terminal 222 of transistor Q1. The other parts of ripple suppression circuit 310 may have the same configurations, functions and alternatives with the corresponding parts of ripple suppression circuit 210, and for ease of illustration, these parts will not be described in detail.

FIG. 4 illustrates yet another ripple suppression circuit 410 according to an embodiment of the present invention. Compared to ripple suppression circuit 310 shown in FIG. 3, a follower circuit of ripple suppression circuit 410 comprises a Darlington transistor Q3. Darlington transistor Q3 may have higher current amplifying factor, and meanwhile has lower power dissipation. The other parts of ripple suppression circuit 410 may have the same configurations, functions and alternatives with the corresponding parts of ripple suppression circuit 310, and for ease of illustration, these parts will not be described in detail.

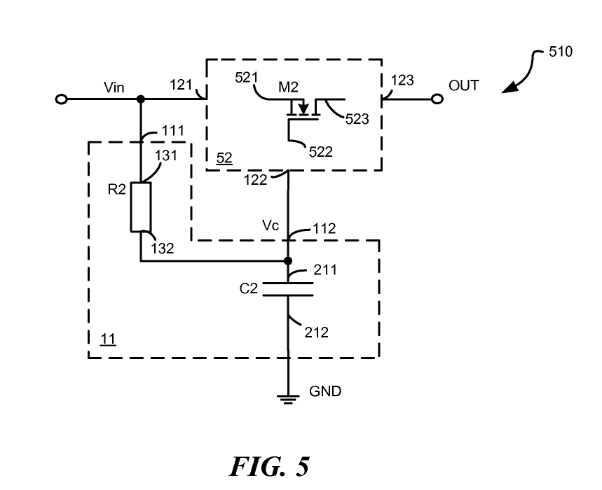

FIG. 5 illustrates a ripple suppression circuit 510 comprising a metal oxide semiconductor field effect transistor (MOSFET) according to an embodiment of the present invention. Ripple suppression circuit 510 comprises a filter circuit 11 and a follower circuit 52. And follower circuit 52 comprises a MOSFET M2. The source 521 of MOSFET M2 is coupled to the first input 121 of follower circuit 52, and to a voltage source having a voltage Vin. The drain 523 of MOSFET M2 is coupled to the output 123 of follower circuit 52 and to a load for providing an output signal OUT. The gate 522 of MOSFET M2 is coupled to the second input 122 of follower circuit 52, and to the output 112 of filter circuit 11. The drain voltage of MOSFET M2 follows and amplifies the gate voltage of MOSFET M2. And the gate voltage of MOSFET M2 follows the filtered voltage Vc. Accordingly, the drain voltage of MOSFET M2 follows the filtered voltage Vc, and compared to the voltage Vin at the source 521, the voltage at drain terminal 523 has low ripple. The output signal OUT of follower circuit 52 is a voltage signal at the drain terminal 523 of MOSFET M2.

In some embodiments, the output signal OUT of follower circuit is power signal, where the power level at the output of the follower circuit follows the filtered voltage and contains low ripple.

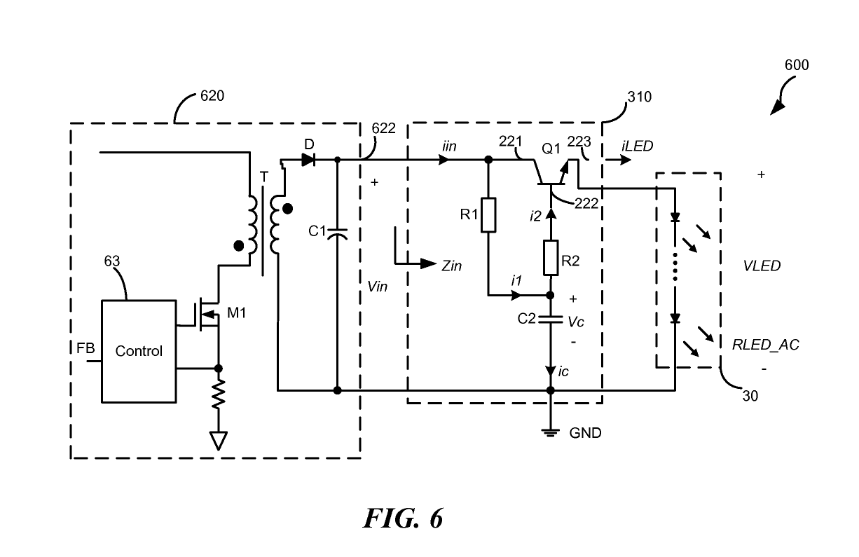

FIG. 6 illustrates a LED power supply system 600 according to an embodiment of the present invention. Power supply system 600 comprises a voltage source 620, a ripple suppression circuit 310 and a load 30.

Voltage source 620 comprises a voltage converter. In the shown embodiment, the voltage converter comprises a single stage PFC voltage converter. Single stage PFC voltage converter 620 converts an AC input voltage into a DC output voltage and presents the output voltage at the output terminal 622. Single stage PFC voltage converter 620 comprises a voltage transformer T, a main switch M1 and a primary side controller 63 with power factor correction. At the secondary side of the voltage transformer T, after filtered by a rectifier D and an output capacitor C1, a DC output voltage Vin is presented at the output terminal 622. In other embodiments, ripple suppression circuit is coupled after a voltage source having topologies other than single stage PFC voltage converter, for example, non-isolated voltage converters and multi-stage PFC voltage converters, in order to decrease the ripple of voltage Vin and supply the load with low ripple. The above mentioned voltage source 620 may have high ripple without a large capacitor C1. With the ripple suppression circuit 310, even if output capacitor C1 has small capacitance, the ripple at the output stage can be suppressed.

In the embodiment shown in FIG. 6, load 30 comprises a LED string having a plurality of LEDs coupled in series. The second terminal 223 of transistor Q1 in ripple suppression circuit 310 forms the output terminal of the ripple suppression circuit 310, and the output current iLED or voltage VLED drives the LED string 30. Load 30 may have other topologies or types.

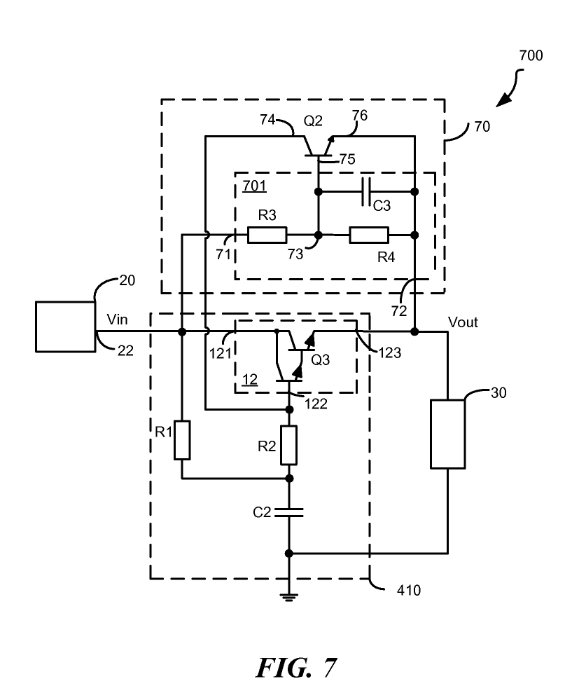

FIG. 7 illustrates a power supply system 700 comprising a short protection circuit 70, according to an embodiment of the present invention. Power supply system 700 comprises a voltage source 20, a ripple suppression circuit 410, a load 30 and a short protection circuit 70. Short protection circuit 70 comprises a voltage detecting circuit 701 and a switch Q2. The voltage detecting circuit 701 has a first terminal 71 coupled to the first input 121 of follower circuit 12, and has a second terminal 72 coupled to the output 123 of the follower circuit 12, the voltage detecting circuit 701 configured to provide a voltage at output 73 of voltage detecting circuit 701 indicating the voltage across the first input 121 and output 123 of the follower circuit. Switch Q2 has a first terminal 74, a second terminal 76 and a control terminal 75, wherein the first terminal 74 of the switch Q2 is coupled to the second input 122 of follower circuit 12, the second terminal 76 of the switch Q2 is coupled to the output 123 of the follower circuit 12, and the control terminal 75 of the switch Q2 is coupled to the output terminal 73 of the voltage detecting circuit 701. When the load is electrically shorted, the voltage across the first input 121 and output 123 of follower circuit 12 is abnormally high and switch Q2 is configured to be turned ON. Accordingly, current is bypassed by switch Q2, and follower circuit 12 of ripple suppression circuit 410 is protected.

In the shown embodiment, voltage detecting circuit 701 comprises a first resistor R3 and a second resistor R4. Resistor R3 is coupled in series with resistor R4. Resistor R3 has a first terminal coupled to the first terminal of the voltage detecting circuit 701 and the first input 121 of the follower circuit 12, and has a second terminal coupled to the output terminal 73 of the voltage detecting circuit. Resistor R4 has a first terminal coupled to the output terminal 73 of the voltage detecting circuit 701, and has a second terminal coupled to the second terminal 72 of the voltage detecting circuit 701 or the output 123 of the follower circuit 12. In the shown embodiment, voltage detecting circuit 701 further comprises a capacitor C3 coupled in parallel with resistor R4 across the first input terminal and the second terminal of resistor R4. In the shown embodiment, switch Q2 comprises a BJT transistor. When load 30 of power supply system 700 is electrically shorted, the voltage Vout across the load approximates zero. And the voltage across the first input 121 and output 123 of follower circuit 12 increases to Vin, and power dissipation of follower circuit 12 would be very high which damages transistor Q3 if without short protection circuit 70. The divider circuit comprising resistors R3 and R4 makes the voltage Vbe of the second transistor Q2 as follows:

$${V}_{be} = ( Vin - Vout ) \cdot \frac{{R}_{4}}{{R}_{4} + {R}_{3}} \qquad ( 1 )$$

In normal operation, the voltage of Vin-Vout is the voltage across the input 121 and output 123 of transistor Q3 and the voltage is low. At the meantime, voltage Vbe is low and is below the conduction voltage of the second transistor Q2, and the second transistor Q2 is in OFF state. When load 30 is shorted, voltage Vout drops to the reference ground level which is deemed as zero voltage, and

$${V}_{be} = Vin \cdot \frac{{R}_{4}}{{R}_{4} + {R}_{3}} \qquad ( 2 )$$

When properly selecting resistor R3 and resistor R4, in short circuit condition, the voltage Vbe is higher than the conduction voltage of the second transistor Q2, and the second transistor Q2 conducts and current flows through the second transistor Q2. During short circuit condition, the second transistor Q2 works under switching mode and the power dissipation is low. Capacitor C3 is used to suppress the voltage spine of output voltage Vout to prevent mistakenly triggering the second transistor Q2 to an ON state. In some embodiments, the second transistor Q2 comprises other type of transistor, such as metal oxide semiconductor field effect transistor (MOSFET). Ripple suppression circuit may have other topologies, such as the topologies shown in FIG. 2 or FIG. 3.

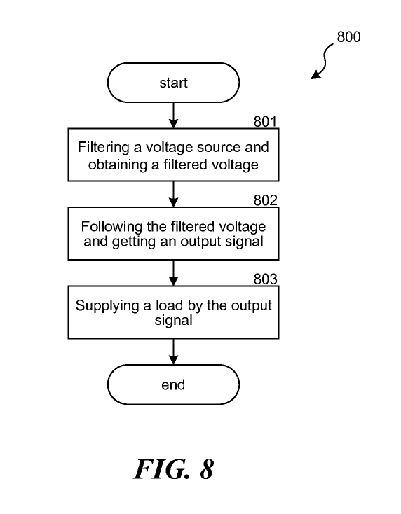

FIG. 8 illustrates a method 800 of suppressing ripple in a power supply system according to an embodiment of the present invention. The ripple suppression method 800 comprises in step 801 filtering a voltage provided by a voltage source, and obtaining a filtered voltage. In step 802, the method comprises generating an output signal based on the filtered voltage and the voltage provided by the voltage source, wherein the output signal follows the filtered voltage which containing low ripple compared to the voltage provided by the voltage source. In one embodiment, the output signal is a current signal which follows the filtered voltage, thus is smooth and the ripple is suppressed. In another embodiment, the output signal is a voltage signal which follows the filtered voltage and the current ripple can also be suppressed when the voltage signal supplies a load. In step 803, method 800 comprises supplying a load by the output signal. In one embodiment, the load comprises a LED.

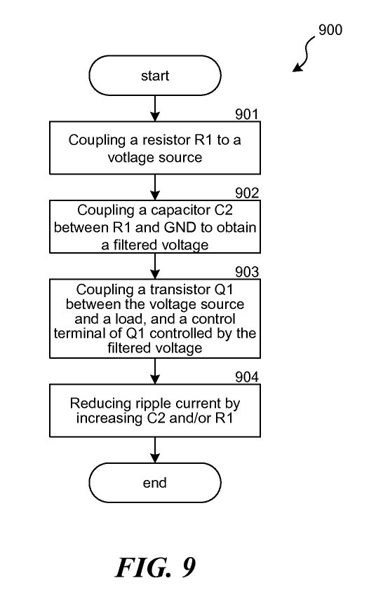

FIG. 9 illustrates a method 900 of suppressing ripple in a power supply system according to an embodiment of the present invention. Method 900 of suppressing ripple in a LED power supply system will be illustrated with reference to FIG. 6. Method 900 comprises increasing the effective AC impedance at the output stage of the power supply system 600. Wherein the output stage of the power supply system 600 comprises ripple suppression circuit 310 and load 30. And the effective AC impedance at the output stage comprises the AC impedance of the module of ripple suppression circuit 310 and load 30. The higher the AC impedance at the output stage is, the low the AC component of the output current is, which means that the ripple current is low. The ripple suppression circuit disclosed in some embodiments the present application is adopted to increase the AC impedance at the output stage of LED power supply system.

Ripple suppression method 900 comprises in step 901, coupling a resistor R1 to a voltage source and in step 902, coupling a capacitor C2 between resistor R1 and reference ground. Step 901 and Step 902 fulfills filtering the voltage provided by the voltage source, and provides a filtered voltage Vc at the common node of resistor R1 and capacitor C2. In step 903, the method of following the filtered voltage Vc comprises coupling a first terminal 221 of transistor Q1 to the voltage source, coupling a second terminal 223 of transistor Q1 to the load, and coupling the control terminal 222 to the filtered voltage Vc. Ripple suppressing method 900 further comprises in step 904 increasing the capacitance of the capacitor C2 and/or the resistance of the resistor R1 to increase the AC impedance at the output stage of power supply system. Accordingly, the ripple of the output current iLED is decreased. In operation, transistor Q1 is turned ON, and the AC output voltage of LED string 30 is:

V_{LED}=i_{LED}·R_{LED}_{_{—}}_{AC} (3)

Where V_{LED} is the AC voltage across LED load 30, i_{LED} is the AC current flowing through the LED load, and R_{LED}_{_{—}}_{AC} is the AC impedance of the LED load 30.

The AC voltage across capacitor C2 is:

v_{c}=i_{LED}·R_{LED}_{_{—}}_{AC}+i₂·R₂ (4)

Combining equation (3) and equation (4), getting that:

$$\begin{matrix}{v}_{in} = {v}_{c} + {i}_{1} \cdot {R}_{1} \\ = {v}_{c} + ( {i}_{2} + \frac{{v}_{c}}{\frac{1}{s {C}_{2}}} ) \cdot {R}_{1} \\ = {i}_{LED} \cdot {R}_{LED\_AC} + {i}_{2} \cdot {R}_{2} + ( {i}_{2} + \frac{{i}_{LED} \cdot {R}_{LED\_AC} + {i}_{2} \cdot {R}_{2}}{\frac{1}{s {C}_{2}}} ) \cdot {R}_{1}\end{matrix} \qquad ( 5 )$$

Where i1 is the current flowing through R1. Thus, the AC impedance of ripple suppression circuit 310 is:

$$\begin{matrix}{Z}_{in} = \frac{{v}_{in}}{{i}_{in}} \\ = \frac{{v}_{in}}{{i}_{LED}} \\ = {R}_{LED\_AC} + \frac{{i}_{2}}{{i}_{LED}} \cdot {R}_{2} + ( \frac{{i}_{2}}{{i}_{LED}} + \frac{{R}_{LED\_AC} + \frac{{i}_{2}}{{i}_{LED}} \cdot {R}_{2}}{\frac{1}{s {C}_{2}}} ) \cdot {R}_{2} \\ = {R}_{LED\_AC} + s {C}_{2} \cdot {R}_{LED\_AC} \cdot {R}_{1} + \frac{1}{β} \cdot ( {R}_{1} + {R}_{2} + s {C}_{2} \cdot {R}_{2} \cdot {R}_{1} )\end{matrix} \qquad ( 6 )$$

Wherein β is the proportion of the emitter current iLED to the base current i2. Thus, AC impedance at the output stage increases when increasing the resistance of resistor R1 and/or increasing the capacitance of capacitor C2. Accordingly, the ripple flowing through LED is decreased. The ripple may be suppressed by increasing the resistance of resistor R2 and/or lowers down β.

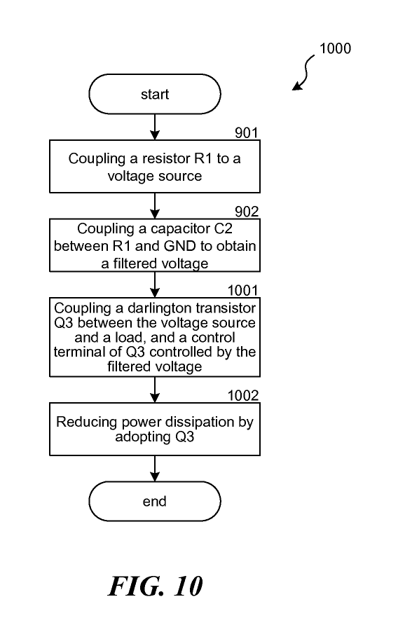

FIG. 10 illustrates a method 1000 of suppressing ripple and decreasing system power dissipation according to an embodiment of the present invention. Method 1000 comprises in step 1001 coupling a first terminal of a Darlington transistor to a voltage source, coupling a second terminal of the Darlington transistor to a load, and coupling a control terminal of the Darlington transistor to a filter circuit. And in step 1002, method 1000 comprises decreasing power dissipation by adopting a Darlington transistor. Steps 901-902 in FIG. 10 are similar to the corresponding steps shown in FIG. 9, and will not be described in detail for simplification.

With reference to FIG. 6, the power dissipation of ripple suppression circuit 310 is:

$$\begin{matrix}{p}_{100} = {i}_{LED} \cdot {v}_{ce} \\ = {i}_{LED} \cdot ( {i}_{1} \cdot {R}_{1} + {i}_{2} \cdot {R}_{2} + {v}_{be} ) \\ = {i}_{LED} \cdot ( ( {i}_{2} + \frac{{v}_{c}}{\frac{1}{s {C}_{2}}} ) \cdot {R}_{1} + {i}_{2} \cdot {R}_{2} + {v}_{be} ) \\ = {i}_{LED} \cdot ( \begin{matrix}{i}_{2} \cdot ( {R}_{1} + {R}_{2} + s {C}_{2} \cdot {R}_{2} \cdot {R}_{1} ) + \\ {i}_{LED} \cdot {R}_{LED\_AC} \cdot s {C}_{2} \cdot {R}_{1} + {v}_{be}\end{matrix} ) \\ = {i}_{LED} \cdot ( \begin{matrix}\frac{{i}_{LED}}{β} \cdot ( {R}_{1} + {R}_{2} + s {C}_{2} \cdot {R}_{2} \cdot {R}_{1} ) + \\ {i}_{LED} \cdot {R}_{LED\_AC} \cdot s {C}_{2} \cdot {R}_{1} + {v}_{be}\end{matrix} )\end{matrix} \qquad ( 7 )$$

Referring to equation (7), when decreasing the resistance of R1 or R2, or decreasing the capacitance of capacitor C2, or increasing β, the power dissipation decreases. In contrast, when increasing the resistance of R1 or R2 or the capacitance of capacitor C2, or lowers down β, the power dissipation of ripple suppression circuit 310 increases. In order to have a tradeoff between suppressing ripple and decreasing power dissipation, transistor Q1 with high β, resistors R1 and R2 with high resistance and capacitor C2 with relative high capacitance may be selected. In one embodiment, a Darlington transistor is adopted to decrease power dissipation, since Darling transistor has high β value.

Combining equation (6) and equation (7), it can be seen that when β is high enough, the component in equations (6) and (7) can be neglected and the tradeoff between suppressing ripple and decreasing power dissipation can be achieved by adjusting resistor R1 and capacitor C2. The selection of resistor R1 and capacitor C2 may be varied according to the requirements in different applications. In one embodiment, resistor R1 is adjustable resistor and capacitor C2 is adjustable capacitor. The capacitance of capacitor C2 and the resistance of resistor R1 can be adjusted to have a tradeoff between suppressing ripple and decreasing power dissipation.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

I/We claim:

1. A power supply system, comprising:
a voltage source configured to provide a voltage;
a load;
a filter circuit having an input and an output, the input of the filter circuit being coupled to the voltage source, the filter circuit configured to filter the voltage provided by the voltage source and provide a filtered voltage at the output of the filter circuit; and
a follower circuit having a first input, a second input and an output, the first input of the follower circuit being coupled to the voltage source, the second input of the follower circuit being coupled to the output of the filter circuit, the follower circuit configured to generate an output signal at the output of the follower circuit based on the filtered voltage, and the output of the follower circuit being coupled to the load configured to supply the load.

2. The power supply system according to claim 1, wherein the filter circuit comprises:
a capacitor having a first terminal and a second terminal, wherein the first terminal of the capacitor is coupled to the output of the filter circuit, and the second terminal of the capacitor is coupled to a reference ground; and
a resistor having a first terminal and a second terminal, wherein the first terminal of the resistor is coupled to the input of the filter circuit, and the second terminal of the resistor is coupled to the first terminal of the capacitor.

3. The power supply system according to claim 1, wherein the follower circuit comprises a transistor, wherein the transistor has a first terminal, a second terminal and a control terminal, and wherein the first terminal of the transistor is coupled to the first input of the follower circuit, the control terminal of the transistor is coupled to the second input of the follower circuit, and the second terminal of the transistor is coupled to the output of the follower circuit, and wherein the output signal of the follower circuit comprises a current signal flowing through the second terminal of the transistor, and the current signal flowing through the second terminal of the transistor follows the filtered voltage.

4. The power supply system according to claim 3, wherein the transistor comprises a bipolar junction transistor.

5. The power supply system according to claim 3, wherein the transistor comprises a Darlington transistor.

6. The power supply system according to claim 3, wherein the follower circuit further comprises a resistor coupled between the output of the filter circuit and the control terminal of the transistor.

7. The power supply system according to claim 1, wherein the voltage source comprises a single stage power factor correction voltage converter.

8. The power supply system according to claim 1, wherein the load comprises a LED.

9. The power supply system according to claim 1, further comprising a short protection circuit, wherein the short protection circuit comprises:
a voltage detecting circuit having a first terminal, a second terminal and an output terminal, wherein the first terminal is coupled to the first input of the follower circuit, the second terminal is coupled to the output of the follower circuit, the voltage detecting circuit configured to provide a voltage indicating the voltage across the first input of the follower circuit and the output of the follower circuit at the output terminal of the voltage detecting circuit; and
a switch having a first terminal, a second terminal and a control terminal, wherein the first terminal of the switch is coupled to the second input of the follower circuit, the second terminal of the switch is coupled to the output of the follower circuit, and the control terminal of the switch is coupled to the output terminal of the voltage detecting circuit, and the switch is configured to be turned ON when the load is electrically shorted.

10. The power supply system according to claim 9, wherein the voltage detecting circuit comprises:
a first resistor having a first terminal and a second terminal, wherein the first terminal of the first resistor is coupled to the first terminal of the voltage detecting circuit, and the second terminal of the first resistor is coupled to the output terminal of the voltage detecting circuit; and
a second resistor having a first terminal and a second terminal, wherein the first terminal of the second resistor is coupled to the output terminal of the voltage detecting circuit, and the second terminal of the second resistor is coupled to the second terminal of the voltage detecting circuit.

11. The power supply system according to claim 10, wherein the short protection circuit further comprises a capacitor coupled across the first terminal of the second resistor and the second terminal of the second resistor.

12. A ripple suppression circuit for suppressing a ripple in a voltage provided by a voltage source and supplying a load, the ripple suppression circuit comprising:
a filter circuit having an input and an output, the input being coupled to the voltage source, the filter circuit configured to filter the voltage provided by the voltage source and provide a filtered voltage at the output of the filter circuit; and
a follower circuit having a first input, a second input and an output, wherein the first input of the follower circuit being coupled to the voltage source, the second input of the follower circuit being coupled to the output of the filter circuit, and the output of the follower circuit configured to provide an output signal generated based on the filtered voltage for supplying the load.

13. The ripple suppression circuit according to claim 12, wherein the filter circuit comprises:
a capacitor having a first terminal and a second terminal, wherein the first terminal of the capacitor is coupled to the output of the filter circuit, and the second terminal of the capacitor is coupled to a reference ground; and
a resistor having a first terminal and a second terminal, wherein the first terminal of the resistor is coupled to the input of the filter circuit, and the second terminal of the resistor is coupled to the first terminal of the capacitor.

14. The ripple suppression circuit according to claim 12, wherein the follower circuit comprises a transistor, the transistor having a first terminal, a second terminal and a control terminal, and wherein the first terminal of the transistor is coupled to the first input of the follower circuit, the control terminal of the transistor is coupled to the second input of the follower circuit, and the second terminal of the transistor is coupled to the output of the follower circuit, wherein the output signal of the follower circuit is a current signal flowing through the second terminal of the transistor, and the current signal flowing through the second terminal of the transistor is configured to follow the filtered voltage.

15. The ripple suppression circuit according to claim 14, wherein the transistor comprises a Darlington transistor.

16. The ripple suppression circuit according to claim 14, wherein the follower circuit further comprises a resistor having a first terminal and a second terminal, wherein the first terminal of the resistor is coupled to the output of the filter circuit, and the second terminal of the resistor is coupled to the control terminal of the transistor.

17. A method of suppressing ripple in power supply system, the method comprising:
filtering a voltage provided by a voltage source and obtaining a filtered voltage;
generating an output signal based on the filtered voltage and the voltage provided by the voltage source; and
supplying a load by the output signal.

18. The method according to claim 17, wherein filtering the voltage comprises coupling a resistor to the voltage source and coupling a capacitor between the resistor and a reference ground, wherein the method of suppressing ripple comprises increasing the capacitance of the capacitor and/or the resistance of the resistor.

19. The method according to claim 17, wherein generating an output signal based on the filtered voltage and the voltage provided by the voltage source comprises:
coupling a first terminal of a transistor to the voltage source;
coupling a second terminal of the transistor to the LED load; and
coupling a control terminal of the transistor to the filtered voltage.

20. The method according to claim 19, further comprising decreasing power dissipation by adopting a Darlington transistor.
